(19) United States
(12) Patent Application Publication
(10) Pub. No.: US 2016/0379590 A1
(43) Pub. Date: Dec. 29, 2016

(54) METHOD, DEVICE AND SYSTEM FOR TRANSMITTING AND IDENTIFYING DATA MAPPING MODE INFORMATION

(71) Applicant: BOE TECHNOLOGY GROUP CO., LTD., Beijing (CN)

(72) Inventors: Xitong MA, Beijing (CN); Xingxing LU, Beijing (CN); Xufang WU, Beijing (CN); Xijiang ZHANG, Beijing (CN)

(73) Assignee: BOE TECHNOLOGY GROUP CO., LTD., Beijing (CN)

(21) Appl. No.: 14/906,164

(22) PCT Filed: Aug. 10, 2015
(86) PCT No.: PCT/CN2015/086444

§ 371 Date: Jan. 19, 2016

(30) Foreign Application Priority Data
Feb. 5, 2015 (CN) 201510061227.1

(51) Int. Cl. G09G 5/00

(52) U.S. Cl. CPC G09G 5/006; G09G 2370/14

(57) ABSTRACT

The present disclosure provides a method and a device for transmitting and identifying a data mapping mode information. The method includes steps of acquiring a first data signal, selecting a mapping mode for transmitting the first data signal, and transmitting the first data signal and information about the mapping mode for transmitting the first data signal to a second terminal via an identical data line.

### CROSS-REFERENCE TO RELATED APPLICATIONS

This application is the U.S. national phase of PCT Application No. PCT/CN2015/086444 filed on Aug. 10, 2015, which claims priority to Chinese Patent Application No. 201510061227.1 filed on Feb. 5, 2015, the disclosures of which are incorporated in their entirety by reference herein.

### TECHNICAL FIELD

The present disclosure relates to the signal transmission for an image display system, in particular to a method, a device and a system for transmitting and identifying a data mapping mode information.

### BACKGROUND

Traditionally, for the video signal transmission, information to be transmitted between a system-on-chip (SOC) and a timer control register (TCON) includes low voltage differential signaling (LVDS) data and information about LVDS data mapping mode (i.e. the LVDS data mapping mode information).

Currently, for the video signal transmission, prior to the transmission of LVDS data, a dedicated data line is required to transmit information about a LVDS data mapping mode, so as to enable the TCON to decode the received LVDS data in accordance with the mapping mode, thereby to obtain the corresponding video information. As a result, the procedure thereof is relatively complex, the production cost is increased and the data transmission efficiency is relatively low.

### SUMMARY

An object of the present disclosure is to provide a method, a device and a system for transmitting and identifying a data mapping mode, so as to simply the procedure as compared with the related art where an additional data line is required to transmit a LVDS data mapping mode during the LVDS data transmission, reduce the production cost and improve the data transmission efficiency.

In one aspect, the present disclosure provides a method for transmitting a data mapping mode, including steps of: acquiring, by a first terminal, a first data signal; selecting a mapping mode for transmitting the first data signal; and transmitting the first data signal and the mapping mode for transmitting the first data signal to a second terminal via an identical data line.

Alternatively, the data line includes a plurality of data signal transmission channels, and the step of transmitting the first data signal and the information about the mapping mode for transmitting the first data signal to the second terminal via the identical data line includes: selecting at least one flag bit from the data signal transmission channels, wherein the at least one flag bit indicates the mapping mode for transmitting the first data signal; setting the flag bit for a data signal in accordance with the mapping mode for transmitting the first data signal; and transmitting the data signal to the second terminal, wherein the data signal includes the first data signal and the information about the mapping mode for transmitting the first data signal.

Alternatively, the step of setting the flag bit in accordance with the mapping mode for transmitting the first data signal includes: when the mapping mode for transmitting the first data signal is a first mapping mode, setting a level signal for the flag bit as being in a high level; and when the mapping mode for transmitting the first data signal is a second mapping mode, setting the level signal for the flag bit as being in a low level.

Alternatively, the first data signal is LVDS of video information, and the flag bit is a reserved bit for a LVDS data transmission format.

Alternatively, the first terminal is a SOC, and the second terminal is a TCON.

In another aspect, the present disclosure provides in some embodiments a method for identifying a data mapping mode, including steps of: receiving, by a second terminal, a data signal transmitted from a first terminal via an identical data line, wherein the data signal includes a first data signal and information about a mapping mode for the first data signal; parsing the data signal to acquire the mapping mode for transmitting the first data signal; and decoding the first data signal in accordance with the mapping mode, so as to acquire decoded data information.

Alternatively, the data line includes a plurality of data signal transmission channels, and the step of parsing the data signal so as to acquire the mapping mode for transmitting the first data signal includes: acquiring information about at least one flag bit received from the data signal transmission channels, wherein the at least one flag bit indicates the mapping mode for transmitting the first data signal; and determining the mapping mode for transmitting the first data signal in accordance with the information about the flag bit.

Alternatively, the step of determining the mapping mode for transmitting the first data signal in accordance with the information about the flag bit includes: determining whether a level signal for the received flag bit is in a high level or a low level; when the level signal for the flag bit is in the high level, determining a first mapping mode as the mapping mode for transmitting the first data signal; and when the level signal for the flag bit is in the low level, determining a second mapping mode as the mapping mode for transmitting the first data signal.

Alternatively, the step of decoding the first data signal in accordance with the mapping mode so as to acquire the decoded data information includes: when the level signal for the flag bit is in the high level, decoding the first data signal in accordance with the first mapping mode, so as to acquire the decoded data information; and when the level signal for the flag bit is in the low level, decoding the first data signal in accordance with the second mapping mode, so as to acquire the decoded data information.

Alternatively, the first data signal is LVDS of video information, and the flag bit is a reserved bit for a LVDS data transmission format.

Alternatively, the first terminal is a SOC, and the second terminal is a TCON.

In yet another aspect, the present disclosure provides a device for transmitting information about a data mapping mode, including: an acquisition unit, configured to acquire a first data signal; a selection unit, configured to select a mapping mode for transmitting the first data signal; and a transmission unit, configured to transmit the first data signal and the information about the mapping mode for transmitting the first data signal to a second terminal via an identical data line.

Alternatively, the data line includes a plurality of data signal transmission channels, and the transmission unit includes: a selection module, configured to select at least one flag bit from the data signal transmission channel, wherein the at least one flag bit indicates the mapping mode for transmitting the first data signal; a setting module, configured to set the flag bit for a data signal in accordance with the mapping mode for transmitting the first data signal; and a transmission module, configured to transmit the data signal to the second terminal, wherein the data signal includes the first data signal and the information about the mapping mode for transmitting the first data signal.

Alternatively, the setting module is configured to: when the mapping mode for transmitting the first data signal is a first mapping mode, set a level signal for the flag bit as being in a high level; and when the mapping mode for transmitting the first data signal is a second mapping mode, set the level signal for the flag bit as being in a low level.

Alternatively, the first data signal is LVDS of video information, and the flag bit is a reserved bit for a LVDS data transmission format.

Alternatively, the second terminal is a TCON.

In still yet another aspect, the present disclosure provides a device for identifying a data mapping mode, including: a reception unit, configured to receive a data signal transmitted from a first terminal via an identical data line, wherein the data signal includes a first data signal and information about a mapping mode for transmitting the first data signal; a parsing unit, configured to parse the data signal to acquire the mapping mode for transmitting the first data signal; and a decoding unit, configured to decode the first data signal in accordance with the mapping mode, so as to acquire decoded data information.

Alternatively, the data line includes a plurality of data signal transmission channels, and the parsing unit includes: an acquisition module, configured to acquire information about at least one flag bit received from the data signal transmission channels, wherein the at least one flag bit indicates the mapping mode for transmitting the first data signal; and a processing module, configured to determine the mapping mode for transmitting the first data signal in accordance with the information about the flag bit.

Alternatively, the processing module is configured to: determine whether a level signal for the received flag bit is in a high level or a low level; when the level signal for the flag bit is in a high level, determine a first mapping mode as the mapping mode for transmitting the first data signal; and when the level signal for the flag bit is in a low level, determine a second mapping mode as the mapping mode for transmitting the first data signal.

Alternatively, the decoding unit includes: a first decoding module, configured to, when the level signal for the flag bit is in the high level, decode the first data signal in accordance with the first mapping mode, so as to acquire the decoded data information; and a second decoding module, configured to, when the level signal for the flag bit is in the low level, decode the first data signal in accordance with the second mapping mode, so as to acquire the decoded data information.

Alternatively, the first data signal is LVDS of video information, and the flag bit is a reserved bit for a LVDS data transmission format.

Alternatively, the first terminal is a SOC.

In still yet another aspect, the present disclosure provides a system for transmitting and identifying information about a data mapping mode, includes a transmission device and an identification device, wherein the transmission device includes: an acquisition unit, configured to acquire a first data signal; a selection unit, configured to select a mapping mode for transmitting the first data signal; and a transmission unit, configured to transmit the first data signal and the information about the mapping mode for transmitting the first data signal to a second terminal via an identical data line; and the identification device including: a reception unit, configured to receive a data signal transmitted from the first terminal via the identical data line, wherein the data signal includes the first data signal and the information about the mapping mode for transmitting the first data signal; a parsing unit, configured to parse the data signal to acquire the mapping mode for transmitting the first data signal; and a decoding unit, configured to decode the first data signal in accordance with the mapping mode, so as to acquire decoded data information.

According to the method, the device and the system for transmitting and identifying a data mapping mode in the embodiments of the present disclosure, the data signal and the information about the mapping mode for transmitting the data signal are transmitted via an identical data line. In this way, it is able to transmit the information about the mapping mode for transmitting the data signal to an opposite terminal during the transmission of the data signal, without any additional data line for transmitting the mapping mode. As a result, it is able to simply the procedure as compared with the related art where the additional data line is required to transmit information about a LVDS data mapping mode during the LVDS transmission, reduce the production cost and improve the data transmission efficiency.

### BRIEF DESCRIPTION OF THE DRAWINGS

In order to illustrate the technical solutions of the present disclosure or the related art in a clearer manner, the drawings desired for the present disclosure or the related art will be described hereinafter briefly. Obviously, the following drawings merely relate to some embodiments of the present disclosure, and based on these drawings, a person skilled in the art may obtain the other drawings without any creative effort.

FIG. 1 is a flow chart of a method for transmitting a data mapping mode according to embodiments of the present disclosure;

FIG. 2 is a flow chart of a method for identifying a data mapping mode according to embodiments of the present disclosure;

FIG. 3 is a flow chart of a method for transmitting and identifying a data mapping mode according to embodiments of the present disclosure;

FIG. 4 is another flow chart of the method for transmitting and identifying a data mapping mode according to embodiments of the present disclosure;

FIG. 5 is a schematic view showing a device for transmitting information about a data mapping mode according to embodiments of the present disclosure;

FIG. 6 is another schematic view showing the device for transmitting a data mapping mode according to embodiments of the present disclosure;

FIG. 7 is a schematic view showing a device for identifying a data mapping mode according to embodiments of the present disclosure;

FIG. 8 is another schematic view showing the device for identifying a data mapping mode according to embodiments of the present disclosure; and

FIG. 9 is yet another schematic view showing the device for identifying a data mapping mode according to embodiments of the present disclosure.

### DETAILED DESCRIPTION

The present disclosure will be described hereinafter in conjunction with the drawings and embodiments. The following embodiments are for illustrative purposes only, but shall not be used to limit the scope of the present disclosure.

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may obtain the other embodiments, which also fall within the scope of the present disclosure.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “connect” or “connected to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

The technical solutions of the present disclosure will be described hereinafter in a clear and complete manner in conjunction with the drawings. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

Referring to FIG. 1, the present disclosure provides in some embodiments a method for transmitting information about a data mapping mode, which includes the following steps.

Step 101: acquiring, by a first terminal, a first data signal. For example, the first terminal may be a SOC, the first data signal acquired by the first terminal may be a LVDS, and the first data signal acquired by the SOC may be information obtained after a format of LVDS is converted into a binary format.

Step 102: selecting, by the first terminal, a mapping mode for transmitting the first data signal. To be specific, the first terminal, e.g., the SOC, may select an appropriate mapping mode for the first data signal in accordance with the first data signal to be transmitted, and a method for selecting the appropriate mapping mode is known in the art.

Step 103: transmitting, by the first terminal, the first data signal and the information about the mapping mode for transmitting the first data signal to a second terminal via an identical data line. To be specific, the first terminal, e.g., the SOC, may select a flag bit from a data signal transmission channel, set the flat bit in accordance with the mapping mode for transmitting the first data signal, and notify the second terminal of the information about the mapping mode by the flag bit, so as to transmit the first data signal and the information about the mapping mode for transmitting the first data signal via an identical data line. The mapping modes for transmitting the LVDS data may include Video Electronics Standards Association (VESA) mode and Japan Electronic Industry Development Association (JEIDA) mode.

According to the method for transmitting information about a data mapping mode in the embodiments of the present disclosure, the data signal and the information about the mapping mode for transmitting the data signal are transmitted via an identical data line. In this way, it is able to transmit the information about the mapping mode for transmitting the data signal to an opposite terminal during the transmission of the data signal, without any additional data line for transmitting the mapping mode. As a result, it is able to simply the procedure as compared with the related art where an additional data line is required to transmit the Information about the LVDS data mapping mode during the LVDS data transmission, reduce the production cost and improve the data transmission efficiency.

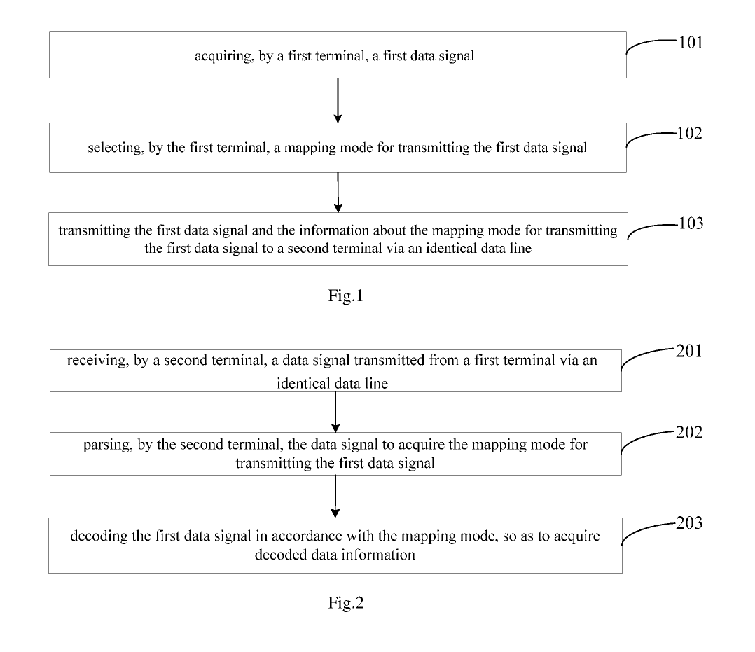

Referring to FIG. 2, the present disclosure provides in some embodiments a method for identifying a data mapping mode, which includes the following steps.

Step 201: receiving, by a second terminal, a data signal including a first data signal and information about a mapping mode for the first data signal from a first terminal via an identical data line. For example, the second terminal may be a TCON.

Step 202: parsing, by the second terminal, the data signal to acquire the information about the mapping mode for transmitting the first data signal. To be specific, the second terminal may parse the received data signal to acquire information carried by a flag bit, and determine the information about the mapping mode for transmitting the first data signal in accordance with the information carried by the flag bit.

Step 203: decoding the first data signal in accordance with the information about the mapping mode, so as to acquire the decoded data information. To be specific, the second terminal, e.g., the TCON, may decode the received data signal in accordance with mapping rules of different mapping modes, so as to acquire the decoded data information.

It should be appreciated that, for the relevant contents in the present embodiment concerning the method for identifying a data mapping mode, it may refer to those in the above-mentioned embodiments concerning the method for transmitting a data mapping mode, and thus will not be repeated herein.

According to the method for identifying a data mapping mode in the embodiments of the present disclosure, it may acquire the information about the mapping mode for transmitting the data signal by processing the received data signal, and then acquire the video information by decoding the received data signal based on the information about the mapping mode. In this way, it is unnecessary for the transmitting terminal to incorporate an additional data line for transmitting the information about the mapping mode. As a result, it is able to simply the procedure as compared with the related art where the additional data line is required to transmit information about the mapping mode for transmitting the LVDS data during the LVDS data transmission, reduce the production cost and improve the data transmission efficiency.

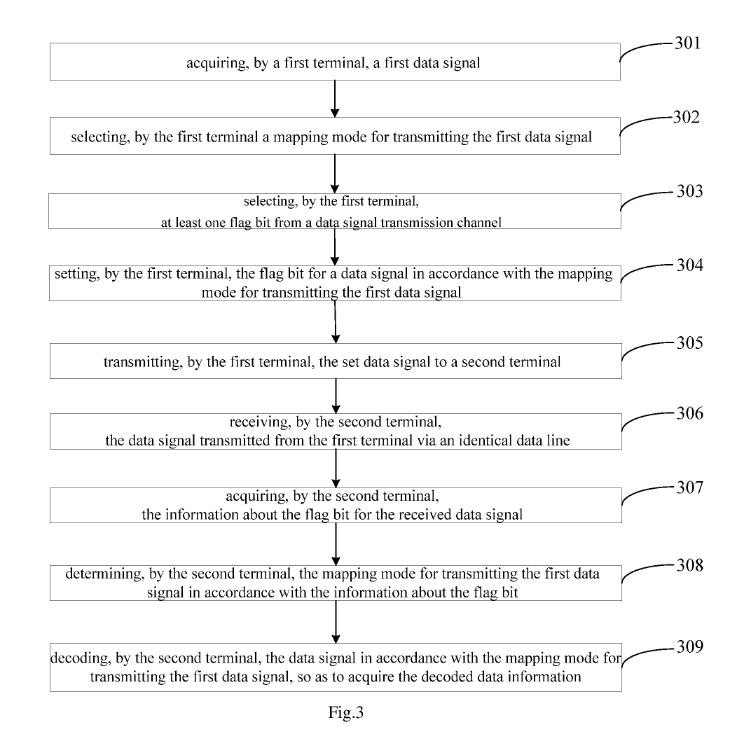

Referring to FIG. 3, the present disclosure provides in some embodiments a method for transmitting and identifying a data mapping mode. A data line includes a plurality of data signal transmission channels, and the method includes the following steps.

Step 301: acquiring, by a first terminal, a first data signal.

Step 302: selecting, by the first terminal, a mapping mode for transmitting the first data signal.

Step 303: selecting, by the first terminal, at least one flag bit from the data signal transmission channels, wherein the at least one flag bit indicates the mapping mode for transmitting the first data signal.

To be specific, if the first data signal is the LVDS data in video information, the flag bit may be a reserved bit for the LVDS data when the LVDS data is transmitted in a corresponding format. For example, when data of each color corresponding to a pixel signal in the data signal has a length of 8 bits, the data signal has a length of 28 bits after it is converted into binary data. The binary data is transmitted through four pairs of transmission channels, i.e., Pair0, Pair1, Pair2 and Pair3, wherein each pair has a length of 7 bits. The binary bits for the pixel signal corresponding to the data signal to be transmitted may be arranged in accordance with a mapping rule of the previously selected mapping mode for transmitting the data signal. At this time, a reserved bit in the data transmission channel for the data signal which has been converted into a binary format, i.e., the most significant bit Bit7REV in Pair3, may be selected to set the information about the mapping mode for transmitting the data signal. Alternatively, when the data of each color corresponding to the pixel signal in the data signal has a length of 10 bits, the data signal has a length of 35 bits after it is converted into binary data. The binary data is transmitted through five pairs of transmission channels, i.e., Pair0, Pair1, Pair2, Pair3 and Pair4, wherein each pair has a length of 7 bits, too. There are two reserved bits in the binary data transmission channels for the data signal, i.e., the most significant bits Bit7 in Pair3 and Pair 4 respectively. At this time, either or both of the most significant bits may be selected to set the information about the mapping mode for transmitting the data signal. In this way, the information about the mapping mode for transmitting LVDS data may be transmitted through the reserved bit of the LVDS data to be transmitted, so it is able to transmit the data in a more convenient manner, and reduce the cost.

Step 304: setting, by the first terminal, the flag bit in accordance with the mapping mode for transmitting the first data signal. To be specific, the first terminal, e.g., the SOC, may set the reserved bit in the data signal in accordance with the mapping mode for transmitting the data signal.

Step 305: transmitting, by the first terminal, the set data signal to a second terminal. The data signal includes the first data signal and the information about the mapping mode for transmitting the first data signal.

Step 306: receiving, by the second terminal, the data signal from the first terminal via an identical data line.

Step 307: acquiring, by the second terminal, the information about the flag bit. To be specific, the second terminal, e.g., the TCON, parses the acquired data signal, and reads the information about the flag bit, i.e., the reserved bit.

Step 308: determining, by the second terminal, the mapping mode for transmitting the first data signal in accordance with the information about the flag bit.

The second terminal, e.g., the TCON, may determine the mapping mode for transmitting the first data signal in accordance with a binary digit in the reserved bit for the acquired data signal. When the binary digit in the reserved bit is 1, the second terminal may determine the mapping mode as a VESA mode, and when the binary digit in the reserved bit is 0, the second terminal may determine the mapping mode as a JEIDA mode. Alternatively, when the binary digit in the reserved bit is 0, the second terminal may determine the mapping mode as a VESA mode, and when the binary digit in the reserved bit is 1, the second terminal may determine the mapping mode as a JEIDA mode. It should be appreciated that, the second terminal, e.g., the TCON, may use a program to parse the received data signal and determine the mapping mode in accordance with the reserved bit in the data signal. The program and its corresponding programming language will not be particularly defined herein, as long as the above-mentioned functions may be achieved.

Step 309: decoding, by the second terminal, the data signal in accordance with the mapping mode for transmitting the first data signal, so as to acquire the decoded data information.

To be specific, the second terminal, e.g., the TCON, may decode the data signal in accordance with the mapping mode for transmitting the first data signal. When the mapping mode is a VESA mode, the second terminal may perform inverse mapping on the received data signal in accordance with a mapping rule of the VESA mode, so as to acquire the corresponding video information. When the mapping mode is a JEIDA mode, the second terminal may perform inverse mapping on the received data signal in accordance with a mapping rule of the JEIDA mode, so as to acquire the corresponding video information.

It should be appreciated that, for the relevant contents in the present embodiment concerning the method for transmitting and identifying a data mapping mode, it may refer to those in the above-mentioned embodiments concerning the methods for transmitting and identifying a data mapping mode, and thus will not be repeated herein.

According to the method for transmitting and identifying a data mapping mode in the embodiments of the present disclosure, the data signal and the information about the mapping mode for transmitting the data signal are transmitted by the first terminal via an identical data line, and the received data signal is parsed by the second terminal to acquire the mapping mode and then decoded in accordance with the acquired mapping mode to acquire the video information. In this way, it is unnecessary for the transmitting terminal to incorporate an additional data line for transmitting the information about the mapping mode. As a result, it is able to simply the procedure as compared with the related art where the additional data line is required to transmit information about the mapping mode for transmitting the LVDS data during the LVDS data transmission, reduce the production cost and improve the data transmission efficiency.

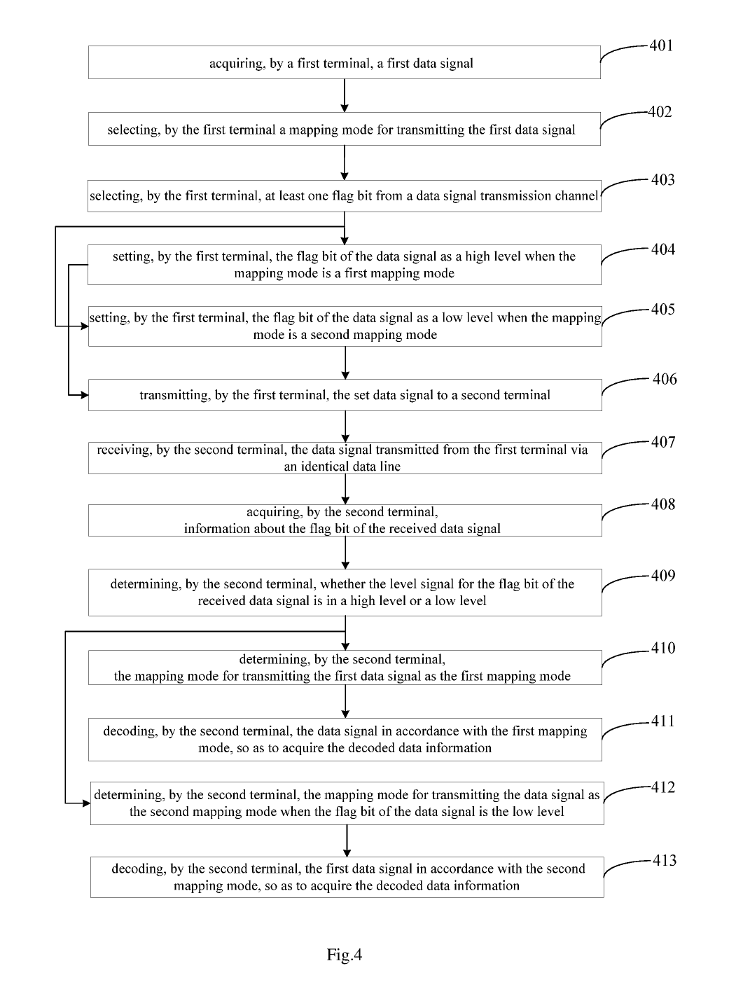

Referring to FIG. 4, the present disclosure provides in some embodiments a method for transmitting and identifying a data mapping mode. A data line includes a plurality of data signal transmission channels, and the method includes the following steps.

Step 401: acquiring, by a first terminal, a first data signal.

Step 402: selecting, by the first terminal, a mapping mode for transmitting the first data signal.

Step 403: selecting, by the first terminal, at least one flag bit from the data signal transmission channel, wherein the at least one flag bit indicates the mapping mode for transmitting the first data signal.

One of Steps 404 and 405 may be selected and performed subsequent to Step 403 in accordance with the mapping mode for transmitting the first data signal. To be specific, when the mapping mode is a first mapping mode, Step 404 is selected and performed, and when the mapping mode is a second mapping mode, Step 405 is selected and performed.

Step 404: setting, by the first terminal, a level signal for the flag bit as a high level.

Step 405: setting, by the first terminal, a level signal for the flag bit as a low level.

The first mapping mode may be a VESA mode, and the second mapping mode may be a JEIDA mode.

Step 406: transmitting, by the first terminal, the set data signal to a second terminal. To be specific, Step 406 is performed subsequent to perform Step 404 or Step 405.

Step 407: receiving, by the second terminal, the data signal from the first terminal via an identical data line.

Step 408: acquiring, by the second terminal, information in the flag bit in the received data signal.

Step 409: determining, by the second terminal, whether the level signal for the flag bit is in a high level or a low level.

Steps 410-411 or Steps 412-413 may be selected and performed subsequent to Step 409 in accordance with the level signal for the flag bit. To be specific, when the level signal is in a high level, Steps 410-411 are selected and performed, and when the level signal is in a low level, Steps 412-413 are selected and performed.

Step 410: determining, by the second terminal, the mapping mode for transmitting the first data signal as the first mapping mode.

Step 411: decoding, by the second terminal, the data signal in accordance with the first mapping mode, so as to acquire the decoded data information. To be specific, the first data signal is converted into parallel data in accordance with the mapping rule of the first mapping mode, so as acquire the decoded data information. For example, the second terminal, e.g., the TCON, may perform inverse mapping on the received first data signal to decode the received first data signal in accordance with the mapping rule of the VESA mode, and convert the received data signal into parallel data, so as to acquire the decoded data information corresponding to the first data signal.

Step S412: determining, by the second terminal, the information about the mapping mode for transmitting the data signal as the second mapping mode.

Step 413: decoding, by the second terminal, the first data signal in accordance with the second mapping mode, so as to acquire the decoded data information. To be specific, the first data signal is converted into parallel data in accordance with the mapping rule of the second mapping mode, so as to acquire the decoded data information. For example, the second terminal, e.g., the TCON, may perform inverse mapping on the received first data signal to decode the received first data signal in accordance with the mapping rule of the JEIDA mode, and convert the received first data signal into parallel data, so as to acquire the decoded data information corresponding to the first data signal.

In Steps 408-413, the second terminal, e.g., the TCON, may use programs to parse the received data signal to acquire the information about the reserved bit in the data signal transmission channel, determine whether a rated level indicated by the information about the reserved bit is the high level or the low level, acquire the mapping mode in accordance with the level signal for the reserved bit, and decode the data signal in accordance with different mapping modes to acquire the video information. In this way, it is able to transmit the information about the mapping mode for LVDS data in a convenient manner through the reserved bit of the LVDS data to be transmitted and by setting the reserved bit correspondingly, thereby to reduce the cost. The programs and their corresponding programming languages will not be particularly defined herein, as long as the above-mentioned functions may be achieved.

It should be appreciated that, for the relevant contents in the present embodiment concerning the method for identifying a data mapping mode, it may refer to those in the above-mentioned embodiments concerning the method for transmitting a data mapping mode, and thus will not be repeated herein.

Alternatively, in the above embodiments, the first mapping mode may be the JEIDA mode, while the second mapping mode may the VESA mode. When the second terminal parses the received data signal, if the level signal for the flag bit is in a high level, the second terminal may parse the received data signal in accordance with the mapping rule of the JEIDA mode so as to acquire the decoded data information corresponding to the first data signal. If the level signal for the flag bit is in a low level, the second terminal may parse the received data signal in accordance with the mapping rule of the VESA mode so as to acquire the decoded data information corresponding to the first data signal.

According to the method for transmitting and identifying a data mapping mode in the embodiments of the present disclosure, the data signal and the information about the mapping mode for transmitting the data signal are transmitted by the first terminal via an identical data line, and the received data signal is parsed by the second terminal to acquire the mapping mode and then decoded in accordance with the mapping mode so as to acquire the video information. In this way, it is unnecessary for the transmitting terminal to incorporate an additional data line for transmitting the information about the mapping mode. As a result, it is able to simply the procedure as compared with the related art where the additional data line is required to transmit the information about the mapping mode for transmitting the LVDS data during the LVDS data transmission, reduce the production cost and improve the data transmission efficiency.

The present disclosure further provides in some embodiments a device 5 for transmitting a data mapping mode, so as to implement any one of the methods as shown in FIGS. 1, 3 and 4. Referring to FIG. 5, the device includes an acquisition unit 51 configured to acquire a first data signal, a selection unit 52 configured to selected a mapping mode for transmitting the first data signal, and a transmission unit 53 configured to transmit the first data signal and the information about the mapping mode for transmitting the first data signal to a second terminal via an identical data line.

According to the device for transmitting a data mapping mode in the embodiments of the present disclosure, the data signal and the information about the mapping mode for transmitting the data signal are transmitted via an identical data line. In this way, it is able to transmit the information about the mapping mode for transmitting the data signal to an opposite terminal during the transmission of the data signal, without any additional data line for transmitting the mapping mode. As a result, it is able to simply the procedure as compared with the related art where an additional data line is required to transmit the Information about the LVDS data mapping mode during the LVDS data transmission, reduce the production cost and improve the data transmission efficiency.

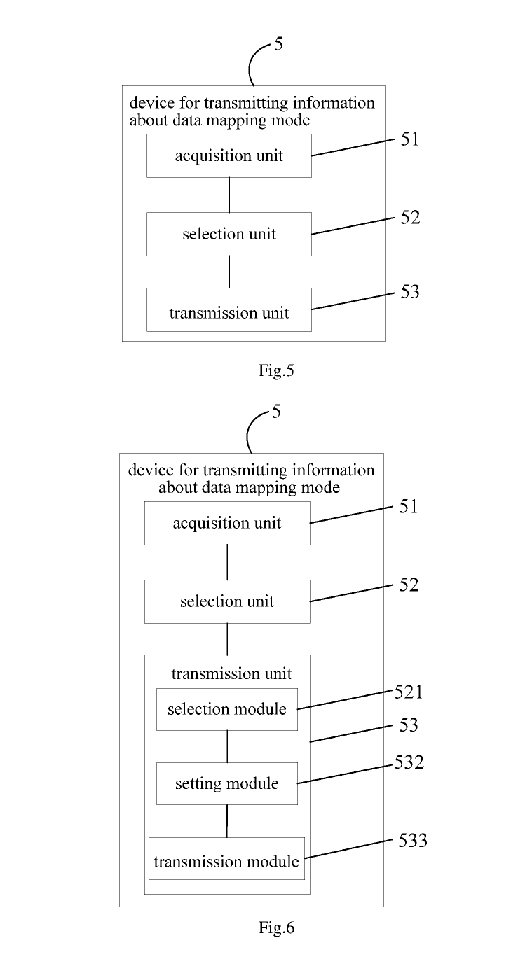

Furthermore, referring to FIG. 6, the data line includes a plurality of data signal transmission channels, and the transmission unit 53 includes a selection module 531 configured to select at least one flag bit from the data signal transmission channel, wherein the at least one flag bit indicates the mapping mode for transmitting the first data signal, a setting module 532 configured to set the flag bit for a data signal in accordance with the mapping mode for transmitting the first data signal, and a transmission module 533 configured to transmit the data signal including the first data signal and the mapping mode for transmitting the first data signal to the second terminal.

Furthermore, the setting module 532 is specifically configured to, when the mapping mode for transmitting the first data signal is a first mapping mode, set a level signal for the flag bit as being in a high level, and when the mapping mode for transmitting the first data signal is a second mapping mode, set the level signal for the flag bit as being in a low level.

To be specific, when the first data signal is LVDS of video information, the flag bit is a reserved bit for a LVDS data transmission format.

It should be appreciated that, for modes for implementing the units and modules of the device and their information interaction in the present embodiment of the present disclosure, it may refer to the above-mentioned embodiments concerning the methods.

According to the device for transmitting a data mapping mode in the embodiments of the present disclosure, the data signal and the information about the mapping mode for transmitting the data signal are transmitted via an identical data line. In this way, it is able to transmit the information about the mapping mode for transmitting the data signal to an opposite terminal during the transmission of the data signal, without any additional data line for transmitting the mapping mode. As a result, it is able to simply the procedure as compared with the related art where the additional data line is required to transmit the information about the mapping mode for transmitting the LVDS data during the LVDS data transmission, reduce the production cost and improve the data transmission efficiency.

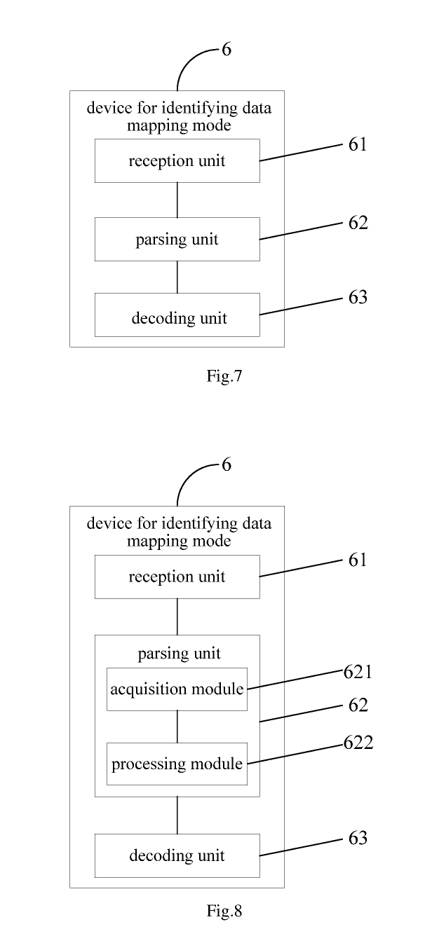

The present disclosure further provides in some embodiments a device 6 for identifying a data mapping mode, so as to implement any one of the methods as shown in FIGS. 2, 3 and 4. Referring to FIG. 7, the device includes a reception unit 61 configured to receive a data signal including a first data signal and a mapping mode for transmitting the first data signal from a first terminal via an identical data line, a parsing unit 62 configured to parse the data signal to acquire the mapping mode for transmitting the first data signal, and a decoding unit 63 configured to decode the first data signal in accordance with the mapping mode, so as to acquire decoded data information.

According to the device for identifying a data mapping mode in the embodiments of the present disclosure, it may acquire the information about the mapping mode for transmitting the data signal by processing the received data signal, and then acquire the video information by decoding the received data signal based on the information about the mapping mode. In this way, it is unnecessary for the transmitting terminal to incorporate an additional data line for transmitting the information about the mapping mode. As a result, it is able to simply the procedure as compared with the related art where the additional data line is required to transmit the information about the mapping mode for transmitting the LVDS data during the LVDS data transmission, reduce the production cost and improve the data transmission efficiency.

Furthermore, referring to FIG. 8, the parsing unit 62 includes an acquisition module 621 configured to acquire the information about the flag bit indicating the mapping mode for transmitting the first data signal, and a processing module 622 configured to acquire the mapping mode for transmitting the first data signal in accordance with the information about the flag bit.

Furthermore, the processing module 622 is specifically configured to determine whether a level signal for the flag bit is in a high level or a low level, when the level signal for the flag bit is in a high level, determine a first mapping mode as the mapping mode for transmitting the first data signal, and when the level signal for the flag bit is in a low level, determine a second mapping mode as the mapping mode for transmitting the first data signal.

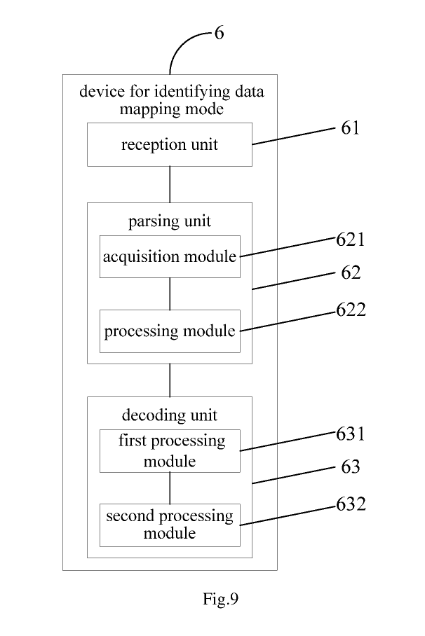

Furthermore, referring to FIG. 9, the decoding unit 63 includes a first decoding module 631 configured to, when the level signal for the flag bit is in a high level, decode the first data signal in accordance with the first mapping mode, so as to acquire the decoded data information, and a second decoding module 632 configured to, when the level signal for the flag bit is in a low level, decode the first data signal in accordance with the second mapping mode, so as to acquire the decoded data information.

When the first data signal is LVDS of video information, the flag bit is a reserved bit for a LVDS data transmission format.

It should be appreciated that, for modes for implementing the units and modules of the device and their information interaction in the present embodiment of the present disclosure, it may refer to the above-mentioned embodiments concerning the methods.

According to the device for identifying a data mapping mode in the embodiments of the present disclosure, the received data signal is parsed to acquire the information about the mapping mode for transmitting the data signal, and then the received data signal is decoded in accordance with the data mapping mode so as to acquire the video information. In this way, it is unnecessary for the transmitting terminal to incorporate an additional data line for transmitting the information about the mapping mode. As a result, it is able to simply the procedure as compared with the related art where the additional data line is required to transmit the information about the mapping mode for transmitting the LVDS data during the LVDS data transmission, reduce the production cost and improve the data transmission efficiency.

It should be appreciated that, all or parts of the steps in the above-mentioned embodiments may be performed by hardware related to programs. The programs may be stored in a computer-readable storage medium, and when the programs are executed, the above-mentioned steps may be performed. The storage medium may include read-only memory (ROM), random-access memory (RAM), a magnetic disc, or an optical disc capable of storing program codes.

The above are merely the preferred embodiments of the present disclosure, and the present disclosure is not limited thereto. A person skilled in the art may make further modifications and improvements without departing from the principle of the present disclosure, and these modifications and improvements shall also fall within the scope of the present disclosure. Thus, the scope of the present disclosure is defined by claims.

What is claimed is:

1. A method for transmitting information about a data mapping mode, comprising steps of:
acquiring, by a first terminal, a first data signal;
selecting a mapping mode for transmitting the first data signal; and
transmitting the first data signal and the information about the mapping mode for transmitting the first data signal to a second terminal via an identical data line.

2. The method according to claim 1, wherein the data line comprises a plurality of data signal transmission channels, and the step of transmitting the first data signal and the information about the mapping mode for transmitting the first data signal to the second terminal via the identical data line comprises:
selecting at least one flag bit from the data signal transmission channels, wherein the at least one flag bit indicates the mapping mode for transmitting the first data signal;
setting the flag bit for a data signal in accordance with the mapping mode for transmitting the first data signal; and
transmitting the data signal to the second terminal, wherein the data signal comprises the first data signal and the information about the mapping mode for transmitting the first data signal.

3. The method according to claim 2, wherein the step of setting the flag bit in accordance with the mapping mode for transmitting the first data signal comprises:
when the mapping mode for transmitting the first data signal is a first mapping mode, setting a level signal for the flag bit as being in a high level; and
when the mapping mode for transmitting the first data signal is a second mapping mode, setting the level signal for the flag bit as being in a low level.

4. The method according to claim 2, wherein the first data signal is low voltage differential signaling (LVDS) of video information, and the flag bit is a reserved bit for a LVDS data transmission format.

5. The method according to claim 1, wherein the first terminal is a system-on-chip (SOC), and the second terminal is a timer control register (TCON).

6. The method according to claim 1, further comprising steps of:
receiving, by the second terminal, a data signal transmitted from the first terminal via the identical data line, wherein the data signal comprises the first data signal and the information about the mapping mode for the first data signal;
parsing the data signal to acquire the mapping mode for transmitting the first data signal; and
decoding the first data signal in accordance with the mapping mode, so as to acquire decoded data information.

7. The method according to claim 6, wherein the data line comprises a plurality of data signal transmission channels, and the step of parsing the data signal so as to acquire the mapping mode for transmitting the first data signal comprises:
acquiring information about at least one flag bit received from the data signal transmission channels, wherein the at least one flag bit indicates the mapping mode for transmitting the first data signal; and
determining the mapping mode for transmitting the first data signal in accordance with the information about the flag bit.

8. The method according to claim 7, wherein the step of determining the mapping mode for transmitting the first data signal in accordance with the information about the flag bit comprises:
determining whether a level signal for the received flag bit is in a high level or a low level;
when the level signal for the flag bit is in the high level, determining a first mapping mode as the mapping mode for transmitting the first data signal; and
when the level signal for the flag bit is in the low level, determining a second mapping mode as the mapping mode for transmitting the first data signal.

9. The method according to claim 8, wherein the step of decoding the first data signal in accordance with the mapping mode so as to acquire the decoded data information comprises:
when the level signal for the flag bit is in the high level, decoding the first data signal in accordance with the first mapping mode, so as to acquire the decoded data information; and
when the level signal for the flag bit is in the low level, decoding the first data signal in accordance with the second mapping mode, so as to acquire the decoded data information.

10. The method according claim 7, wherein
the first data signal is low voltage differential signaling (LVDS) of video information, and the flag bit is a reserved bit for a LVDS data transmission format; and
the first terminal is a system-on-chip (SOC), and the second terminal is a timer control register (TCON).

11. (canceled)

12. A device for transmitting information about a data mapping mode, comprising:
an acquisition unit, configured to acquire a first data signal;
a selection unit, configured to select a mapping mode for transmitting the first data signal; and
a transmission unit, configured to transmit the first data signal and the information about the mapping mode for transmitting the first data signal to a second terminal via an identical data line.

13. The device according to claim 12, wherein the data line comprises a plurality of data signal transmission channels, and the transmission unit comprises:
a selection module, configured to select at least one flag bit from the data signal transmission channels, wherein the at least one flag bit indicates the mapping mode for transmitting the first data signal;
a setting module, configured to set the flag bit for a data signal in accordance with the mapping mode for transmitting the first data signal; and
a transmission module, configured to transmit the data signal to the second terminal, wherein the data signal comprises the first data signal and the information about the mapping mode for transmitting the first data signal.

14. The device according to claim 13, wherein the setting module is configured to:
when the mapping mode for transmitting the first data signal is a first mapping mode, set a level signal for the flag bit as being in a high level; and
when the mapping mode for transmitting the first data signal is a second mapping mode, set the level signal for the flag bit as being in a low level.

15. The device according to claim 13, wherein
the first data signal is low voltage differential signaling (LVDS) of video information, and the flag bit is a reserved bit for a LVDS data transmission format; and
the second terminal is a timer control register (TCON).

16. (canceled)

17. A device for identifying a data mapping mode, comprising:
a reception unit, configured to receive a data signal transmitted from a first terminal via an identical data line, wherein the data signal comprises a first data signal and information about a mapping mode for transmitting the first data signal;
a parsing unit, configured to parse the data signal to acquire the mapping mode for transmitting the first data signal; and
a decoding unit, configured to decode the first data signal in accordance with the mapping mode, so as to acquire decoded data information.

18. The device according to claim 17, wherein the data line comprises a plurality of data signal transmission channels, and the parsing unit comprises:
an acquisition module, configured to acquire information about at least one flag bit received from the data signal transmission channels, wherein the at least one flag bit indicates the mapping mode for transmitting the first data signal; and
a processing module, configured to determine the mapping mode for transmitting the first data signal in accordance with the information about the flag bit.

19. The device according to claim 18, wherein the processing module is configured to:
determine whether a level signal for the received flag bit is in a high level or a low level;
when the level signal for the flag bit is in the high level, determine a first mapping mode as the mapping mode for transmitting the first data signal; and
when the level signal for the flag bit is in the low level, determine a second mapping mode as the mapping mode for transmitting the first data signal.

20. The device according to claim 19, wherein the decoding unit comprises:
a first decoding module, configured to, when the level signal for the flag bit is in the high level, decode the first data signal in accordance with the first mapping mode, so as to acquire the decoded data information; and
a second decoding module, configured to, when the level signal for the flag bit is in the low level, decode the first data signal in accordance with the second mapping mode, so as to acquire the decoded data information.

21. The device according to claim 18, wherein
the first data signal is low voltage differential signaling (LVDS) of video information, and the flag bit is a reserved bit for a LVDS data transmission format; and
the first terminal is a system-on-chip (SOC).

22. (canceled)

23. A system for transmitting and identifying information about a data mapping mode, comprising: a transmission device and an identification device, wherein
the transmission device comprises: an acquisition unit, configured to acquire a first data signal; a selection unit, configured to select a mapping mode for transmitting the first data signal; and a transmission unit, configured to transmit the first data signal and the information about the mapping mode for transmitting the first data signal to a second terminal via an identical data line; and
the identification device comprising: a reception unit, configured to receive a data signal transmitted from the first terminal via the identical data line, wherein the data signal comprises the first data signal and the information about the mapping mode for transmitting the first data signal; a parsing unit, configured to parse the data signal to acquire the mapping mode for transmitting the first data signal; and a decoding unit, configured to decode the first data signal in accordance with the mapping mode, so as to acquire decoded data information.
